(19) United States
(12) Patent Application Publication
(10) Pub. No.: US 2024/0387069 A1
(43) Pub. Date: Nov. 21, 2024

(54) X-Ray Scanning Module and System with Electronic Gating

(71) Applicant: Viken Detection Corporation, Burlington, MA (US)

(72) Inventor: Peter J. Rothschild, Newton, MA (US)

(21) Appl. No.: 18/319,456

(22) Filed: May 17, 2023

Related U.S. Application Data
(60) Provisional application No. 63/364,858, filed on May 17, 2022.
(60) Provisional application No. 63/368,633, filed on Jul. 15, 2022.

(51) Int. Cl. G21K 1/04; G01V 5/00

(52) U.S. Cl. CPC G21K 1/043; G01V 5/222; G01V 5/224

(57) ABSTRACT

An x-ray scanning module includes an x-ray source having an electronic gate configured to have an ON state wherein the electronic gate enables the x-ray source to provide source x-rays, and to have an OFF state wherein the electronic gate disables the x-ray source from providing the source x-rays. The x-ray source is configured to receive a control signal that sets the electronic gate to the ON state and the OFF state selectively. The module further includes a rotatably mounted chopper wheel configured, when the electronic gate is in the ON state, to receive the source x-rays from the x-ray source and to provide a scanning beam output, wherein rotation of the chopper wheel causes scanning of the scanning beam output. Corresponding systems and methods can have benefits including reducing interference in arrangements that are multi-view or include a radiation portal monitor.

### TECHNICAL FIELD

The present invention relates x-ray scanning modules, systems, and methods, and more particularly to use of electronically gated x-ray sources in such modules, systems, and methods, including in multi-view x-ray scanning and where radiation portal monitors (RPMs) are employed together with x-ray scanning.

### BACKGROUND ART

X-ray backscatter imaging has been used for detecting concealed contraband, such as drugs, explosives, and weapons, since the late 1980's. Unlike traditional transmission x-ray imaging that creates images by detecting the x-rays penetrating through an object, backscatter imaging uses reflected or scattered x-rays to create the image. Transmission imaging may also be performed using the same x-ray beam that is used for backscatter imaging. X-ray scanning and imaging maybe be used in many settings, including in vehicle portals that obtain multiple views of a target vehicle that passes through the portal.

Together with some x-ray imaging systems, it can be advantageous to use radiation portal monitors (RPMs) to monitor passively for radioactive materials.

### SUMMARY OF THE EMBODIMENTS

Better methods are needed to limit interference between different detectors in multi-view x-ray imaging systems and between x-ray scanners and radiation portal monitors (RPMs) that may be included in these systems.

In accordance with first embodiment of the invention, an x-ray scanning module includes an x-ray source having an electronic gate configured to have an ON state wherein the electronic gate enables the x-ray source to provide source x-rays, and to have on OFF state wherein the electronic gate disables the x-ray source from providing the source x-rays. The x-ray source is configured to receive a control signal that sets the electronic gate to the ON state and the OFF state selectively. The module further includes a rotatably mounted chopper wheel configured, when the electronic gate is in the ON state, to receive the source x-rays from the x-ray source and to provide a scanning beam output, wherein rotation of the chopper wheel causes scanning of the scanning beam output.

In accordance with a second embodiment of the invention, an x-ray scanning system includes the x-ray scanning module consistent with the first embodiment, as well as a controller configured to output the control signal to the x-ray source and to set, via the control signal, the electronic gate to the ON state and the OFF state selectively.

In accordance with a third embodiment of the invention, an x-ray imaging system includes:
a first electronically gated x-ray source configured to have an activated state and a deactivated state;
a second electronically gated x-ray source configured to have an activated state and a deactivated state;
one or more controllers that control the first and second electronically gated x-ray sources such that only one selected one of the first and second electronically gated x-ray sources is in the activated state at a given time;
one or more x-ray detectors positioned to receive x-rays from both the first and second electronically gated x-ray sources, wherein the x-rays are scattered by the target, transmitted through the target, or both; and
one or more image generators configured to create an image of the target based on signals from at least one of the one or more x-ray detectors when the first x-ray source is active,
wherein the one or more image generators are further configured to create an image of the object based on signals from at least one of the one or more x-ray detectors when the second x-ray source is active.

In accordance with a fourth embodiment of the invention, a system for x-ray imaging one or more targets with one or more continuous-beam x-ray sources in close proximity to one or more radiation portal monitors includes:
one or more continuous-beam x-ray sources, wherein at least one of the one or more x-ray sources is configured to be electronically gated so as to have a selection of states including an activated state and an inactivated state;
one or more radiation portal monitors (RPMs);
a blanking signal controller configured to generate a blanking signal that deactivates the one or more continuous-beam x-ray sources during a blanking period;
one or more x-ray detectors positioned to receive x-rays from the one or more x-ray sources that are scattered by, or transmitted through, the one or more objects;
an image generator configured to create one or more images of the one or more targets based on signals from at least one of the one or more x-ray detectors when at least one of the one or more continuous-beam x-ray sources is in the activated state; and
an RPM signal controller configured to detect passive ionizing radiation emitted passively from the one or more targets during periods when the at least one electronically gated x-ray source is in the inactivated state, the detected passive ionizing radiation based on signals from at least one of the one or more RPMs.

In accordance with a fifth embodiment of the invention, a method of manufacturing an x-ray scanning module includes configuring a chopper wheel to receive source x-rays from an electronically gated x-ray source and to be rotatable to produce a scanning beam output from the chopper wheel when the source x-rays are received. The method further includes configuring the electronically gated x-ray source to receive a control signal and to respond to the control signal by entering an ON state and an OFF state selectively, the ON state of the electronic gate enabling the x-ray source to provide the source x-rays to be received at the chopper wheel, and the OFF state of the electronic gate disabling the x-ray source from providing the source x-rays.

In accordance with a sixth embodiment of the invention, a method of operating an x-ray scanning module includes causing a chopper wheel to receive source x-rays from an x-ray source and to rotate to produce a scanning beam output from the chopper wheel when the source x-rays are received. The method further includes electronically gating the x-ray source to disable, selectively, the x-ray source from producing the scanning beam output.

### BRIEF DESCRIPTION OF THE DRAWINGS

The foregoing features of embodiments will be more readily understood by reference to the following detailed description, taken with reference to the accompanying drawings, in which:

FIG. 1 (prior art) is a perspective-view illustration of an x-ray transmission imaging system utilizing a scanning beam of x-rays, the illustration showing principles applicable to backscatter and transmission x-ray imaging implemented in embodiment systems.

FIGS. 2A-2C (prior art) illustrate rotating disk, rotating wheel, and rotating hoop types of x-ray chopper wheels, respectively, that have been used for backscatter imaging systems.

FIG. 3 (prior art) is a perspective-view illustration of a tilted or “angled” disk chopper wheel x-ray scanning module that can be advantageously used in embodiments.

FIG. 4A is a schematic block diagram illustrating an electronically gated x-ray source that may be used advantageously in embodiments.

FIG. 4B is a schematic diagram illustrating a particular electronically gated x-ray source, an x-ray tube with a gating grid, that may be used advantageously in embodiments.

FIG. 5 is a schematic block diagram illustrating an embodiment x-ray scanning module incorporating the electronically gated x-ray source of FIG. 4A.

FIG. 6 is a schematic block diagram illustrating an embodiment x-ray scanning system incorporating the x-ray scanning module of FIG. 5.

FIG. 7 is schematic block diagram illustrating an embodiment x-ray imaging system in which two electronically gated x-ray sources are implemented with a controller to ensure that only one of the x-ray sources at a time is in an activated (ON) state emitting x-rays used for scanning.

FIG. 8 is a schematic block diagram illustrating an embodiment x-ray imaging system that includes a radiation portal monitor (RPM) that can monitor for passive radiation from a target without interference from x-rays that are used for imaging the target.

FIG. 9 (prior art) is a schematic diagram illustrating portions of an existing multi-view vehicle portal x-ray scanning system intended to prevent interference between scanners by temporal interleaving.

FIG. 10 is a schematic diagram illustrating an embodiment x-ray scanning system implemented as a multi-view Z-portal system that includes electronically gated x-ray sources to prevent interference between x-ray scanners and between x-ray scanners and an RPM.

FIG. 11 is a graph showing an example energy spectrum acquired with a plastic scintillator detector for four different radioactive sources.

FIG. 12 is a schematic diagram illustrating blanking (gating) signal flow in an embodiment multi-source x-ray scanning system.

FIG. 13 is an example master timing diagram for an embodiment x-ray scanning system having both x-ray scanning and RPM monitoring capabilities.

FIG. 14 is an alternative example master timing diagram for an embodiment x-ray scanning system having both x-ray scanning and RPM monitoring capabilities.

FIG. 15 is a flow diagram illustrating an embodiment method of providing an x-ray scanning beam.

FIG. 16 is a flow diagram illustrating an embodiment method of controlling an x-ray scanning beam.

### DETAILED DESCRIPTION OF SPECIFIC EMBODIMENTS

Definitions. As used in this description and the accompanying claims, the following terms shall have the meanings indicated, unless the context otherwise requires:

A “set” includes at least one member.

A “continuous-beam” x-ray source is an x-ray source that is configured to provide, absent an electronic gate, an x-ray beam output of a sufficiently consistent intensity during a period of time required for a target to be x-ray imaged. An example period of time can be on the order of, and include, 1 second, 5 seconds, 30 seconds, 1 minute, 10 minutes, and the like. Sufficiently consistent intensity is an intensity that is uniform enough in time to perform x-ray imaging according to standards understood by those of skill in the art of x-ray scanning using vehicle portals, handheld x-ray scanners, luggage scanners, personnel scanners, and the like as of the date of filing this application. An example “continuous-beam” x-ray source as used herein can be based on the Bremsstrahlung effect, such as in an x-ray vacuum tube (“x-ray tube”). A “continuous-beam” x-ray source as used herein excludes a linear accelerator (Linac) operating in pulsed mode.

“Electronic gate,” “electronically gated,” and like terms, as used herein, refer to gating that can permit an x-ray source to stop production of x-rays without mechanically blocking an x-ray beam that is output from the x-ray source. Mechanically blocking an x-ray beam includes using a mechanical shutter, for example, such as a mechanical shutter of a high-Z material, for example, to block x-rays.

“Blanking” and “gating” are used herein with the similar meanings and should be understood the same way unless the context indicates otherwise. For example, in some contexts, a “blanking signal” and a “gating signal” refer to the same type of signal, which can set, directly or indirectly, an electronic gate to an ON state and to an OFF state at different times selectively. In other contexts, “blanking” refers more specifically to setting the “blanking signal” or “gating signal” such that an electronic gate is in an OFF state at selected times (in this context, it will be readily understood that the same electronic gate may also be configured to be set to, or allowed to remain in, an ON state when it is not set to the OFF state).

“Target object,” “target,” and “object” are used interchangeably herein and refer to a subject that may be scanned by an x-ray scanner for imaging or sensed for any passive radiation emitted from the subject.

As used herein, “substantially non-perpendicular” indicates that the angle Θ is small enough to increase effective thickness significantly, such as increasing effective thickness by more than 25%, more than 50%, more than 100% (an effective thickness multiplier of 2), more than 200%, or more than 400%.

“Active,” “activated,” and ON are used interchangeably herein in relation to a state of an electronic gate.

“Inactive,” “inactivated,” and OFF are used interchangeably herein in relation to a state of an electronic gate.

Existing interleaved multi-view x-ray backscatter imaging systems have used mechanical means of interleaving the beams, such as by synchronized rotation of chopper wheels that produce the respective x-ray scanning beams. There are several disadvantages associated with mechanically interleaving the beams. First, all the x-ray sources are continuously energized, even during the periods when the x-ray beams are inactive and not being used to create an image, resulting in multiple times more electrical energy usage and heat. Second, because multiple sources are interleaved, the existing temporally interleaved systems provide only a fraction of the image scan lines compared with a non-interleaved system wherein the three x-ray sources can be spaced apart from one another. If chopper wheels were rotated faster to compensate with such a system, then this would result in a reduction in the Signal to Noise Ratio (SNR) of the acquired image.

Embodiments of the current invention use electronically gated x-ray sources to energize the x-ray sources sequentially in a temporally interleaved multi-view x-ray backscatter imaging system, such that the respective x-ray sources energized continuously. The gating may be performed, for example, by using a grid located close to the cathode. By applying a small negative gating voltage to the grid, the electrons are deflected out of the accelerating potential, and return to ground without striking the anode and creating any output x-rays.

Electronically gating the sources has several advantages over the method described above, in which the x-rays sources are continuously energized, and the x-ray beams are temporally interleaved using purely mechanical means, such as the synchronized chopper wheels. First, because the electrical power supplied to each x-ray source only occurs during the time-period that the beam from the source is needed for imaging, there is a reduction of a factor of N (where N is the number of sources) in the total combined power consumption compared with a prior art system with the same number of continuously energized sources. This also results in a reduction in the generated heat load from the x-ray source anodes of a factor of N, meaning that the cooling capacity of the combined system can be smaller, lower cost, and more power efficient. Secondly, electronic gating allows the power supplied to each x-ray source to be increased beyond the maximum rating allowed for continuous operation. By gating the n sources so that they are each only energized for (1/N) of the time, the power supplied during the energized period can be increased by a certain factor (depending on the details of how fast and efficiently heat can be transferred out of the anode) without causing damage to the x-ray source anode. This can then overcome some of the reduction in the SNR due to interleaved sources that was described previously. The rotation speed of the chopper wheels can be increased by a factor of N to provide the same number of image lines as a non-interleaved system, and the reduction in pixel acquisition time of a factor of nN can be compensated for with an increase in source power, resulting in a smaller reduction in image SNR than would otherwise be the case. Of course, this increase in power can then reduce some of the power and heat load savings; however, the result is a very compact, temporally interleaved system with improved image quality and somewhat lower power consumption than a completely non-interleaved system wherein the sources are spaced apart, which can be a major advantage when space for a scanning system is limited.

Since 2003, multi-view x-ray backscatter imaging portals for vehicles have been available, featuring temporally interleaved x-ray beams. For examples, three sweeping x-ray beams have been used to acquire left, right, and top-down backscatter images simultaneously. The three scanning beams can be sequenced temporally, and because only one x-ray beam is configured to be incident on a target at any given time, the sources can be mounted so that the beams are essentially coplanar, still minimizing or eliminating issues of crosstalk between the three views. This has allowed systems to be more compact along the direction of motion of the vehicle target, as all three sources could be mounted on a single portal structure.

Radiation Portal Monitors (RPMs) are installed at many border crossings and ports to detect the presence of illicit radioactive materials concealed within vehicles or shipping containers. RPMs typically include large volumes of plastic scintillating material such as PVT optically coupled to Photomultiplier Tubes (PMTs) that detect the scintillation light when x-rays or gamma rays deposit their energy in the plastic. The amount of scintillation light produced is proportional to the energy of absorbed x-ray or gamma ray. By measuring the intensity of all the output current pulses produced by the PMTs, an energy spectrum of the absorbed photons can be produced

RPMs are usually quite large so that they can be sensitive enough to detect weak radioactive sources (typically 5,000-25,000 cm3 of plastic scintillator). This also makes them very sensitive to interference from any nearby x-ray source. This is not a problem for pulsed x-ray sources such as linear accelerators (linacs) that are used in multi-MeV high-energy x-ray imaging, as the pulses are so short (a few microseconds) and so intense that they can easily be detected and blanked out using software. This is not the case, however, for continuous-beam x-ray sources, such as those used in x-ray backscatter imaging (with continuous sweeping pencil beams) or traditional x-ray transmission imaging (with continuous fan beams of radiation). For these continuous-beam sources, the RPMs are typically separated from the x-ray imaging systems by hundreds of feet to prevent any significant interference. At border crossings or ports where space is at a premium, this is often not possible, and it is certainly not desirable.

A practical means of using one or more x-ray imaging systems with continuous sources in close proximity to RPMs is needed for many locations where space is limited, and one such means is described in this patent application.

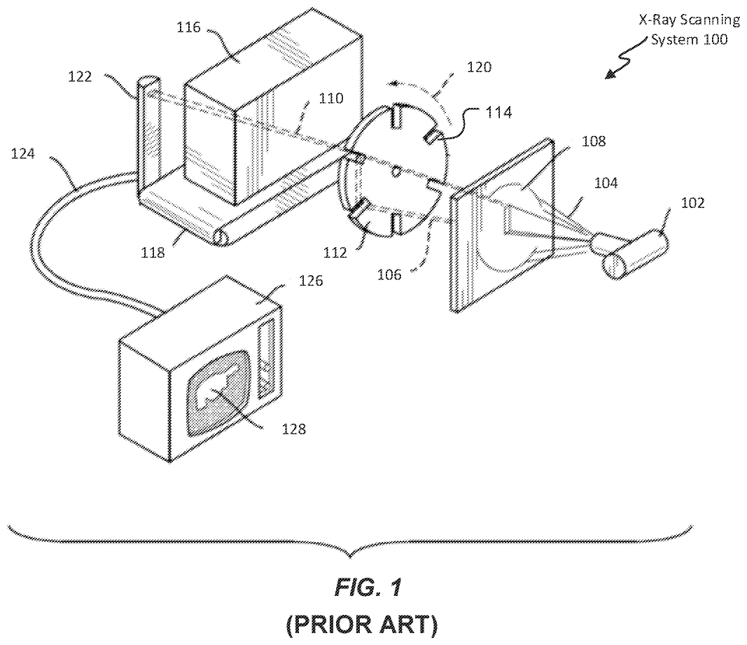

FIG. 1 (prior art) illustrates basic principles of backscatter imaging in reference to a transmission imaging system 100 that uses a scanning x-ray beam in a manner similar to a backscatter imaging system. A standard x-ray tube 102 generates source x-rays 104 that are collimated into a fan beam 106 by a slit aperture in attenuating plate 108. The fan beam 106 is then “chopped” into a scanning pencil beam 110 by a rotating “chopper wheel” 12 defining slit apertures (which may also be referred to herein as “slits”) 114 therein. The scanning pencil beam 110 thus scans over target object 116 (in this example a suitcase on a conveyor 118 being imaged as the chopper wheel 112 rotates with a rotation 120.

In the transmission imaging system 100 as illustrated, x-rays of the scanning pencil beam 110 that are transmitted through the target 116 are detected by a transmission x-ray detector 122, which outputs a signal via a signal cable 124 to a monitor 126, which shows an image 128 of contents of the target 116. In the same type of system, while not shown in FIG. 1, backscatter x-ray detectors may be positioned to detect x-rays from the pencil beam 110 that are scattered by the target 116 in a general or specific backward direction, such as in a vicinity between the target 116 and the chopper wheel 112. An intensity of the x-rays scattered in the backwards direction may be thus recorded by one or more large-area backscatter detectors (not shown) as a function of the position of the illuminating beam. In the case of backscatter detectors, it can be advantageous to use large-area detectors in order to detect the greatest number of x-rays scattered in various specific backward directions. By moving the object through the plane containing the scanning beam, either on a conveyor 118 or under its own power, a two-dimensional backscatter image of the object may be obtained.

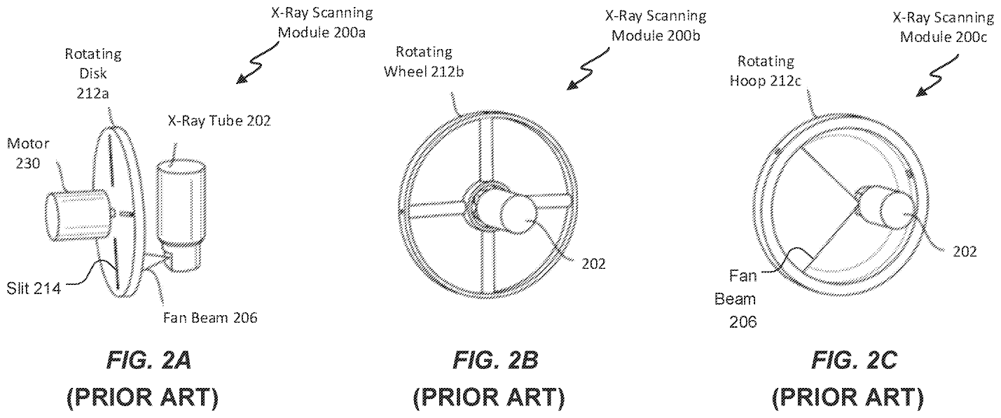

FIGS. 2A-2C (prior art) illustrate three different types of existing x-ray chopper wheels used for generating a scanning pencil beam from a substantially stationary wide x-ray beam emanating either directly from an x-ray tube 202 or from the x-ray tube 202 and through an intermediary collimation plate such as the collimation plate 108 of FIG. 1, for example. The chopper wheel of existing x-ray backscatter imaging systems usually is one of three basic types: a rotating disk chopper wheel (which may also referred to herein as a “disk” or “disk chopper wheel”) 212a, a rotating wheel chopper wheel (which may also be referred to herein as a “hub-and-spoke” chopper wheel) 212b, or a rotating hoop chopper wheel (which may also be referred to herein as a “hoop” chopper wheel) 212c. The three types are shown in FIGS. 2A, 2B, 2C, respectively, in x-ray scanning modules 200a, 200b, 200c, respectively. The chopper wheels 212a, 212b, 212c can be rotatably mounted in various ways that are known in the art of x-ray scanning. FIG. 2A illustrates one way of causing a chopper wheel to rotate, wherein the disk chopper wheel 212a is coupled to a shaft of a motor 230. Slits 214 defined within the disk chopper wheel 212a serve a purpose similar to that of the slits 114 in FIG. 1.

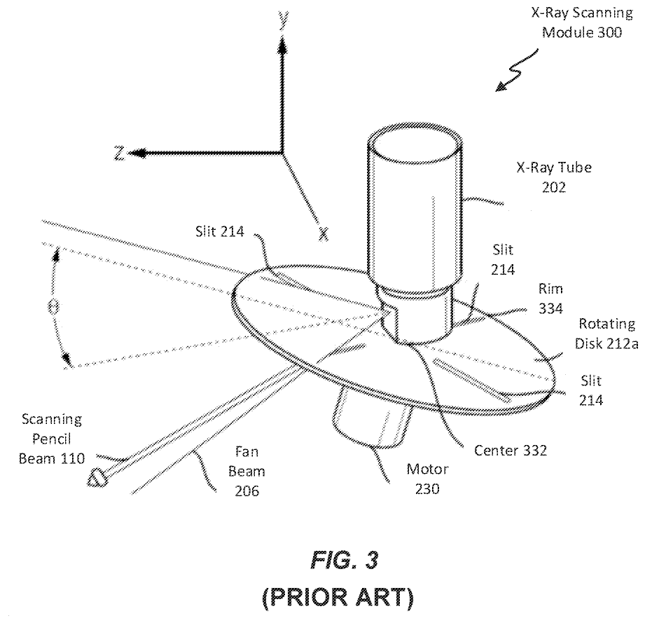

FIG. 3 (prior art) illustrates an x-ray scanning module 300. The module 300 is a more recent modification of the x-ray scanning module 200a of FIG. 2A, which has been modified in the x-ray scanning module 300 in a “tilted chopper wheel” (also referred to as an “angled chopper wheel”) configuration to significant advantage. The x-ray scanning module 300 can be a particularly compact and relatively low-weight x-ray scanning module. This design is particularly advantageous in mobile scanning device applications, as it allows a smaller and lower-cost motorized vehicle with a lower maximum chassis load limit to be used. In a larger, vehicle-or cart-based mobile scanning system, it also allows a vehicle, trailer, or cart that supports the x-ray scanning module to be smaller, lighter, and more maneuverable. Thus, where the embodiments described herein may not have even been feasible or desirable previously, given the weight, expense, and difficulty of handling two massive chopper wheels in a given system, or one such massive chopper wheel on a mobile conveyance, the tilted design can solve the long-standing associated problems. Tilted disk chopper wheels are described more fully in patent U.S. Pat. No. 10,762,998, which is hereby incorporated by reference herein in its entirety. This chopper wheel assembly is compact, and by tilting the disk, the assembly enables a disk chopper wheel design to be used more easily at x-ray energies above 200 kV. The compactness and low weight of the tilted disk chopper wheel x-ray scanning module makes it ideal to be used on a mobile platform, and especially for a mobile dual-sided inspection system for embodiment x-ray scanning modules, systems, and methods described herein.

FIG. 3 particularly illustrates an orientation of a fan beam 328 output from an x-ray tube 202 and disk chopper wheel 212a in greater detail. The x-ray tube 202 is oriented with an axis in the Y direction. The fan beam 206 of source x-rays that are output from the x-ray tube 202 is oriented in the X-Z plane (the X-Z plane contains the fan beam 206). The plane of rotation of the chopper disk lies at an oblique non-perpendicular angle Θ to the X-Z plane. The scanning pencil beam 110 also is scanned in the X-Z plane, i.e., the beam plane, as the chopper disk rotates. The disk chopper wheel 212a includes a rim 334 and center 332, and the slits 214 are oriented to extend radially toward the rim and center. The chopper disk 212a is rotated by means of a motor 230.

The chopper disk 212a is not oriented in either the X-Z plane or the X-Y plane, but, rather, in a disk plane that is at an angle Θ with respect to the beam plane (X-Z plane) of the fan beam 206. The disk plane can also be referred to as a plane of rotation (or rotational plane) of the chopper disk 212a, because the disk remains parallel to this plane as it rotates. The disk plane can be parallel to the X axis. By positioning the plane of the rotating disk at an acute (substantially non-perpendicular) angle Θ to the plane of the fan beam, the actual thickness of the disk can be reduced by a factor F=1/sin(Θ) while keeping the disk's effective thickness the same. As used herein, “substantially non-perpendicular” indicates that the angle Θ is small enough to increase effective thickness significantly, such as increasing effective thickness by more than 25%, more than 50%, more than 100% (an effective thickness multiplier of 2), more than 200%, or more than 400%.

Any of the x-ray scanning modules 200a, 200b, 200c and 300 may be modified to include electronically gated x-ray sources for use in connection with embodiments described herein. This can be done, for example, by replacing the x-ray tube 202, which does not include electronic gating function, with an x-ray source that has an electronic gate and can be controlled via a gating signal as described hereinafter.

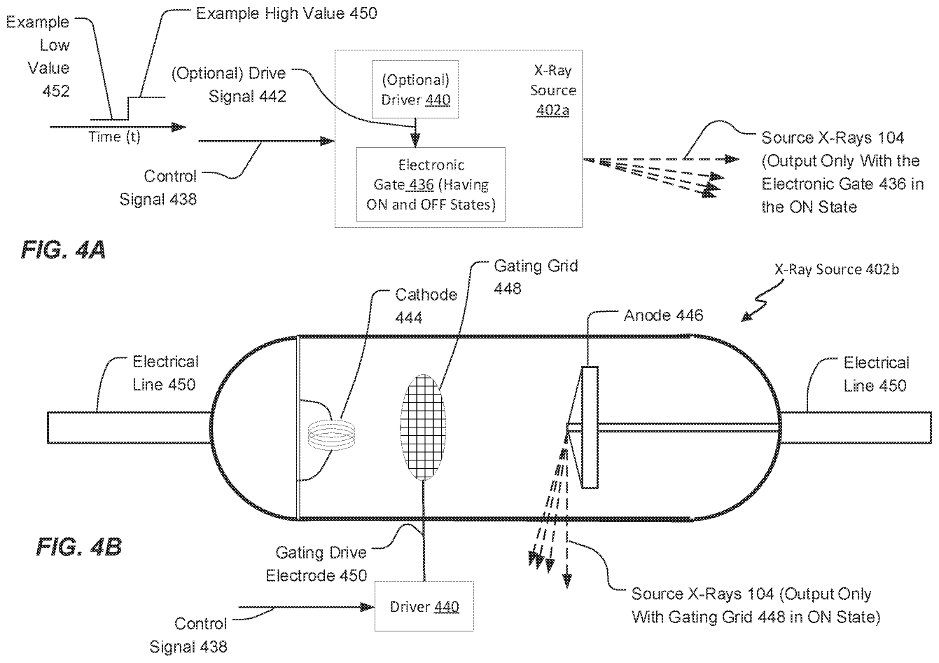

FIG. 4A is a schematic block diagram illustrating a generalized x-ray source 402a that may be advantageously used in embodiments. The x-ray source 402a includes an electronic gate 436 having ON and OFF states. The x-ray source 402a is configured to receive a control signal 438 that results in setting the electronic gate 436 to the ON state and an OFF states, selectively at different times. This setting may be done in different ways. As one example, the control signal 438 may be a digital signal and have high and low values 450, 452, respectively, corresponding to the ON and OFF states of the electronic gate 436. However, the control signal 438 may also be an analog signal or a digital signal with more complex instructions to the x-ray source 402a. The control signal 438 may be received at an optional driver 440 in the x-ray source 402a, which can in turn supply power to drive the electronic gate 436 as shown. The optional driver 440 may be part of the x-ray source 402a as shown in FIG. 4A. Alternatively the optional driver 440 may be external to the x-ray source. In the example shown in FIG. 4A, the optional driver 440 provides an optional drive signal 442, which is received to drive the electronic gate 436 to switch between the ON and OFF states. However, in embodiments wherein the optional driver 440 is external to the x-ray source 402a, the control signal 438 may be received at the optional driver 440, and the drive signal 442, received at the x-ray source 402a, may be considered to be the control signal received at the x-ray source 402a. The control signal 438 may be electrical. Alternatively, it may be optical or wireless, for example, with appropriate optoelectronic converters or other means to deliver an electrical drive signal to drive the electronic gate 436.

In the ON state, the electronic gate 436 enables the X-ray source 402a to provide and to output source x-rays 104. In the OFF state, the electronic gate is configured to disable the X-ray source 402a from providing and outputting the source x-rays 104. FIG. 4B illustrates one example of how these functions may be performed in an x-ray tube source with a gating grid.

FIG. 4B is a more particular example of an x-ray source 402b that can be used in embodiments. The x-ray source 402b is a vacuum tube x-ray source, including a cathode 444, which is heated to provide a source of electrons, and an anode 446 configured to receive electrons that are accelerated through an electric field between the two electrodes. The source x-rays 104 may thus be produced in response to electrons received at the anode 446. Electrical lines 450 supply electrical power to the cathode and anode of the x-ray source 402b.

The x-ray source 402b further includes a gating grid 448 that serves as the electronic gate having ON and OFF states. When the gating grid 448 is negatively charged, it can interfere with flow of electrons between the cathode and anode and, thus, disable the x-ray source 402b from providing the source X-rays 104. In contrast, the gating grid 448 can be set not to be negatively charged, permitting the flow of electrons across the tube and enabling the x-ray source 402b to output and provide the source x-rays 104. In the example of the x-ray source 402b, the driver 440 is external to the x-ray source x-ray tube. The control signal 438 is received by the driver 440, which supplies a drive signal to the gating grid 448 via a gating drive electrode 450.

By using electronically gated x-ray sources, such as those for FIGS. 4A-4B, in an x-ray scanning system having a number N of x-ray sources, each of the N sources can be electrically energized only during the period that is required for that source, and it can be done in a manner such that x-ray production from the sources does not interfere with system performance. For example, if a system with three x-ray sources were to use a chopper disk (disk chopper wheel) rotating at 6,000 rpm with three slit apertures, similar to the disk chopper wheel shown in FIG. 3, then the system would acquire 300 lines of scan data per second, or one scan line every 3.3 milliseconds. The x-ray sources could then be sequentially gated to allow each source in turn to be sequentially energized for a period of about 3.3 ms to ensure that only one beam of source x-rays is active (activated) at any given time. In this example, each source is only energized for ⅓ of the time, and it would therefore be advantageous to increase the x-ray power by a factor of three to compensate for this reduction in on-time. The actual power that the tube can withstand during the 3.3 ms that it is energized requires heat-flow calculations on the anode to be carried out. This is a function of the anode material (typically tungsten) and the specific design of the anode cooling method that is used. It is typically the case that the maximum power at which the tube can be operated with a duty cycle of 1/n will not be N times the continuous maximum power. This is because the heat flow does not reach equilibrium during the brief time that the source is energized. For example, an x-ray tube with a tungsten anode that typically operates at 2.4 kW in continuous operation may only be able to operate at twice the power (4.8 kW) for a period of 3.3 ms without the heat load starting to melt the tungsten anode. However, this factor of two still provides a large advantage in terms of the quality of the acquired image, increasing the signal-to-noise ratio (SNR) by about 40%.

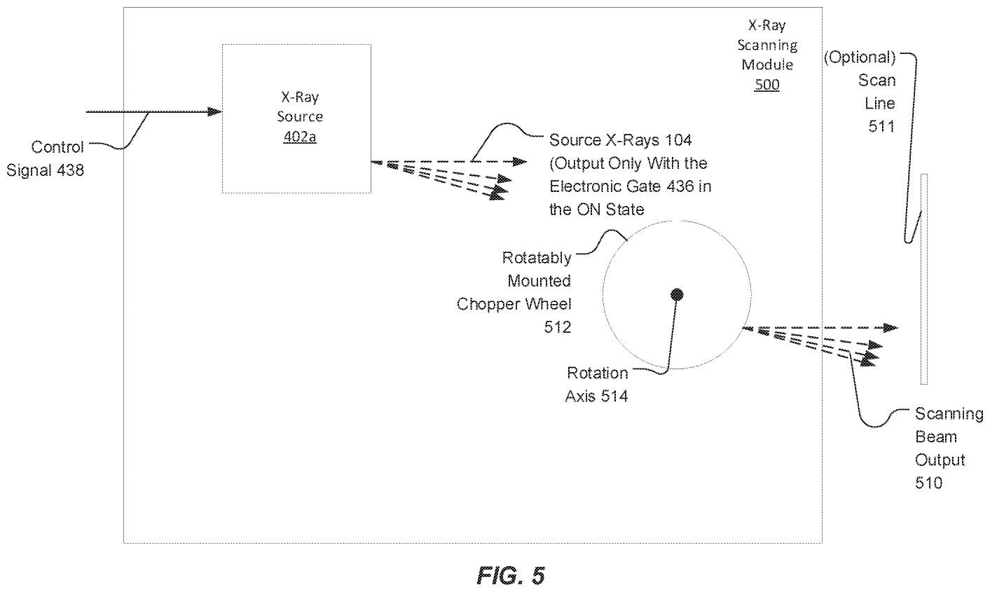

FIG. 5 is a schematic diagram illustrating an embodiment x-ray scanning module 500 and has reference further to FIGS. 1-4B. The x-ray scanning module 500 includes the x-ray source 402a, which is configured to receive the control signal 438 and to output the source x-rays 104 when the electronic gate 436 (illustrated in FIG. 4A) is in the ON state.

The x-ray scanning module 500 further includes a rotatably mounted chopper wheel 512, which can include a wheel such as the wheels 112, 212a, 212b, 212c described hereinabove. The rotatably mounted chopper wheel 512 has a rotation axis 512 that can be used for mounting the chopper wheel 512. Specific mounting can include many different types of chopper wheel mountings that are known in the art for various types of chopper wheels. In a simple example, a shaft of the motor 230 in FIG. 2A is coupled directly to a rotation axis of the rotating disk chopper wheel 212a.

In an ON state of the electronic gate in the x-ray source 402a, the rotatably mounted chopper wheel 512 is configured to receive the source x-rays from the x-ray source 402a and to provide a scanning beam output 510. Rotation of the chopper wheel 512, such as the rotation 120 in FIG. 1, causes the scanning of the scanning beam output 510. Optionally, the scanning beam output 510 can be a scanning pencil beam, such as the scanning pencil beam 110 illustrated in FIGS. 1 and 3. The scanning output beam 510 may optionally form a scan line 511. Many scan lines over a target that is moved relative to the x-ray scanning module 500 can be used to form an image of the target, as is known in the art. Advantageously, with the electronic gating of the x-ray source 402a, the x-ray scanning module 500 becomes far more versatile and can be used in a wide variety of different circumstances and embodiments, including handheld instruments, multi-view x-ray scanning portals, x-ray scanning systems having radiation portal monitors included in close proximity, etc. Various example embodiment x-ray scanning modules, systems, and related methods are provided hereafter, without limitation to the specific embodiments that are given by way of illustration.

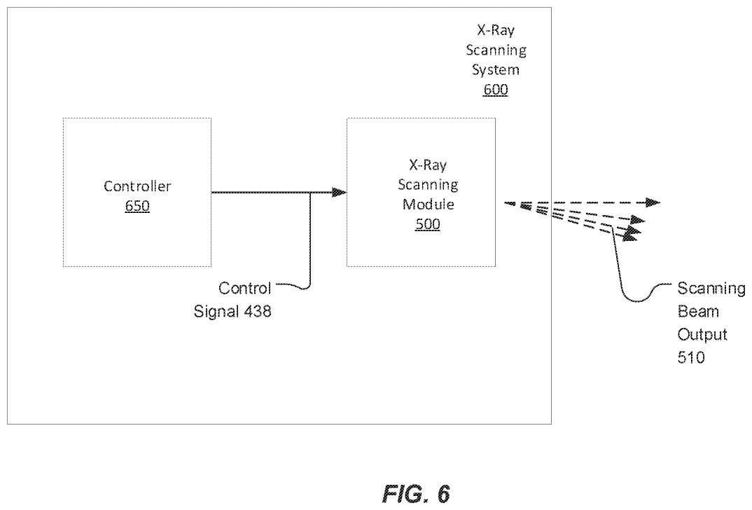

FIG. 6 is a schematic block diagram illustrating a generalized embodiment x-ray scanning system 600. The system 600 includes the x-ray scanning module 500 of FIG. 5. The system 600 further includes a controller 650 that is configured to output the control signal 438 to the x-ray scanning module 500. The control signal 438 may then be received directly by the x-ray source. Alternatively, the control signal 438 may be received at the x-ray source indirectly, via another module such as the gating driver 440 of FIG. 4B, which outputs a drive signal to the electronic gate 436 of FIG. 4A, such as to the gating grid 448 of FIG. 4B, for example.

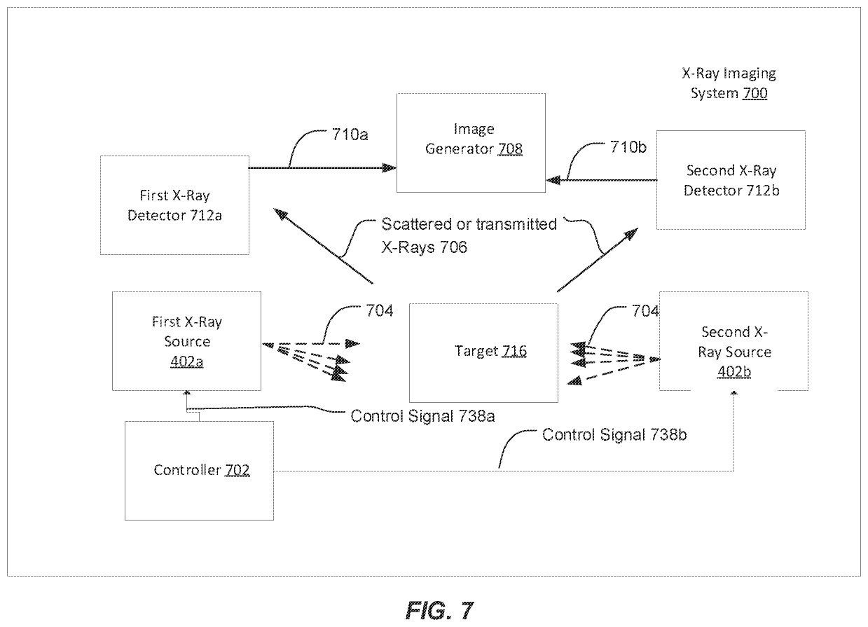

FIG. 7 is a schematic diagram illustrating an embodiment x-ray imaging system 700, which can be used for imaging a target object with two or more x-ray sources. The x-ray sources need not include scanning mechanisms such as a chopper wheel, but instead can be any x-ray source with the electronic gate of FIG. 4A. The system 700 includes first and second x-ray sources 402a and 402b, with the x-ray source 402b having the same features as the x-ray source 402a, which was described in relation to FIG. 4A. Both of the x-ray sources output source x-rays 704 toward a target 716. The x-ray sources 402a, 402b are electronically gated and configured to be controlled by a controller 702 via respective control signals 738a, 738b. In other embodiments, a single timing signal may be provided, and the x-ray sources 402a, 402b may include logic to respond to the control signals appropriately. The controller 702 ensures that only one of the x-ray sources 402a, 402b is active (outputting an x-ray) at a given time. In this manner, each of the x-ray sources is configured to be in an activated mode or a deactivated mode at a given moment, depending on control by the controller 702. The electronically gated x-ray sources may be gated in a manner illustrated in FIG. 4B, by way of example.

The system of FIG. 7 also illustrates a first x-ray detector 712a, on the left, and an optional second x-ray detector 712b on the right. In various embodiments, one or more x-ray detectors, including many more x-ray detectors that are shown in FIG. 7, may be included. The x-ray detectors are positioned to receive the x-rays 706 from both the first and second x-ray sources that are either scattered by a target object 716 (not part of the) or transmitted through the target object. As will be understood to those of ordinary skill in the art of x-ray scanning, the first and second x-ray detectors may be positioned in various locations to receive the desired x-rays 706, whether scattered x-rays, such as backscattered or forward scattered x-rays, or side scattered x-ray, or x-rays of the source x-rays 704 that are transmitted from the sources through the target object.

FIG. 7 also illustrates an image generator 708 configured to create an image of the target object based on signals that are received from the detectors, namely the first and second (optional) detectors. In particular, the image generator 708 is configured to create an image of the target object based on signals 710a, 710b from the respective detectors that are received when the first x-ray source, on the left, is active. The image generator is further configured to create an image of the target object based on signal from one or both of the detectors when the second x-ray source 402b, on the right, is in the activated (ON) state.

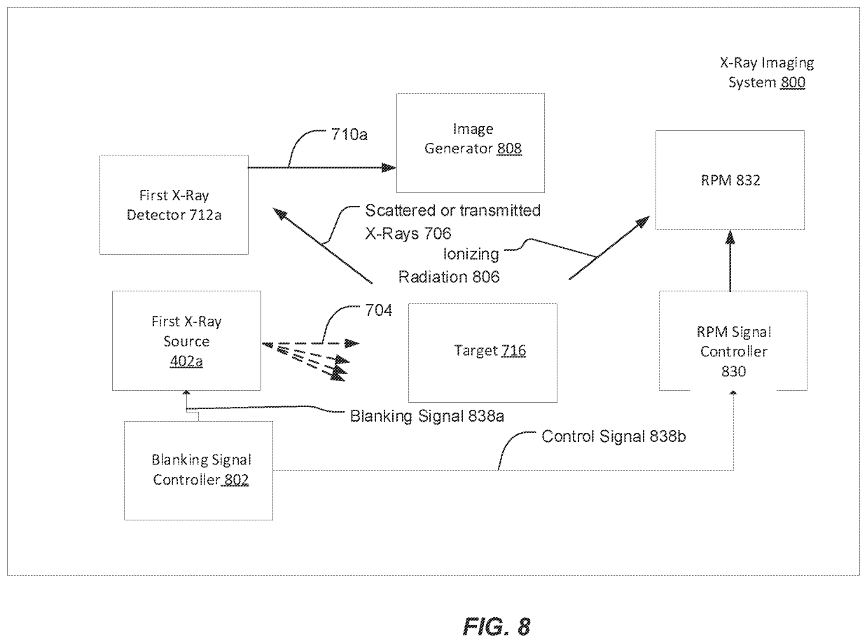

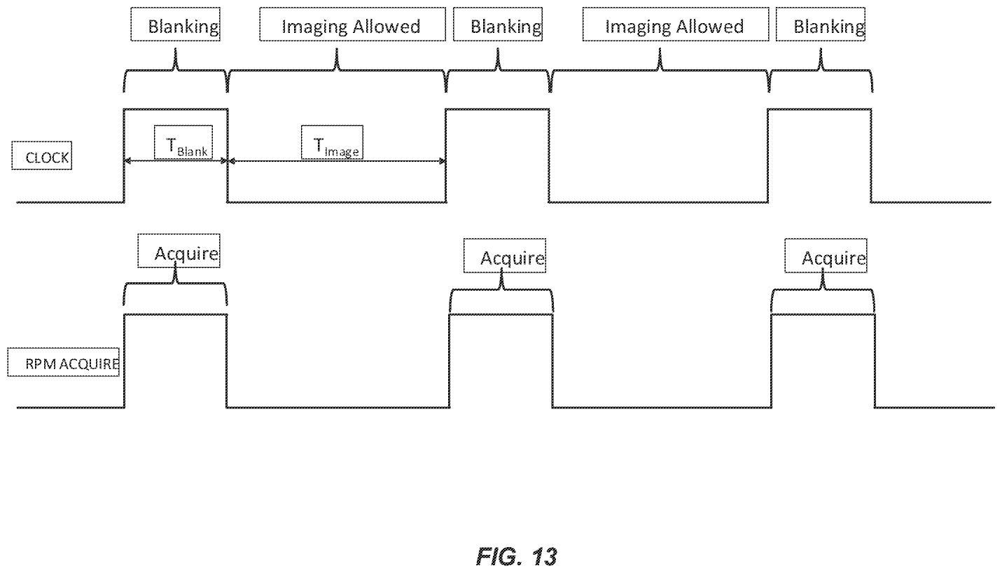

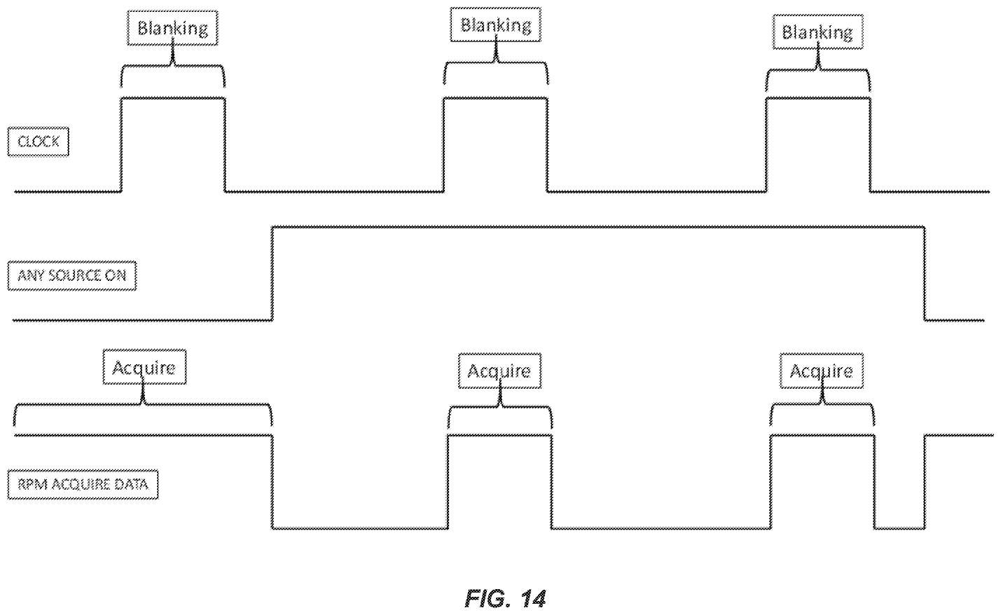

FIG. 8 is a schematic block diagram illustrating an embodiment x-ray imaging system 800, which includes RPM detection. The system 800 includes a blanking signal controller 802, which outputs a blanking signal 838 to a first x-ray source 402a, which is a continuous beam x-ray source. As described previously, the x-ray source 402a is electronically gated having ON and OFF states that may be referred to herein as an activated state and an inactivated state, respectively. The blanking signal controller 802 generates a blinking signal 838a that deactivates the first x-ray source during a blanking period. Blanking periods are described further in relation to FIGS. 13-14, for example. The first x-ray detector 712a receives the scattered or transmitted x-rays 706 from the target 716, similar to FIG. 7. An image generator 808 is configured to create one or more images of the target object 716 based on signals 710a from the first X-ray detector 712a. This occurs when the first x-ray source 402a is in the activated state, outputting source x-rays 704. An RPM signal controller 830 controls an RPM 832, which detects any ionizing radiation 806 that is received from the target 716. The ionizing radiation 806 is emitted passively from the target during periods. The RPM signal controller 830 causes the detection to occur, or to be counted, only during periods when the x-ray source 402a is in the inactivated state The passive ionizing radiation 806 may be considered to be detected, as used herein, when it is based on signals that are output from the RPM 832 only during the blanking period of the X-ray source 402a, such that the x-rays 704 and 706 do not interfere with detection of the passive ionizing radiation 806. A control signal 838b from the controller 802 to the controller 830 may be the same as, or differ from, the blanking signal 838a, and the logic in the RPM signal controller 830 can respond appropriately to achieve the RPM behavior noted above. Accordingly, interference may be avoided in the RPM detection in a very effective manner, even with the RPM in close proximity to the source 402a, x-rays 706, and target 716.

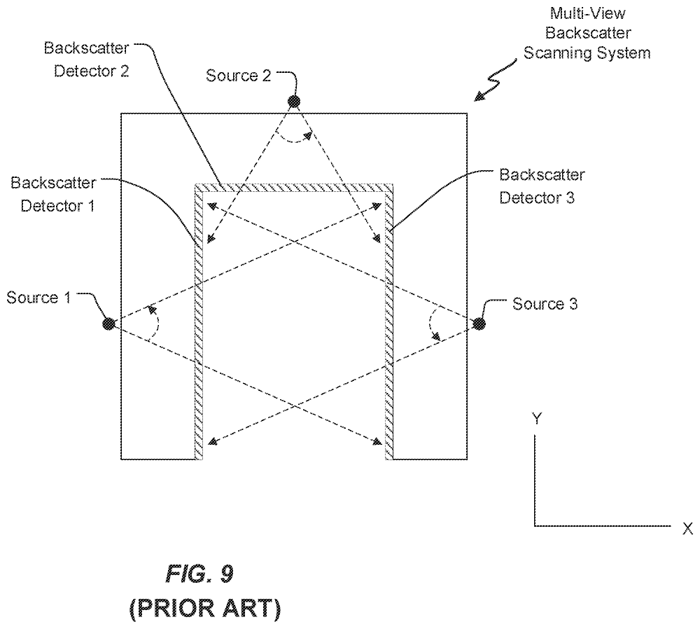

FIG. 9 (prior art) illustrates an existing multi-view x-ray backscatter imaging portal for vehicles that has temporally interleaved x-ray beams. The system includes three sweeping x-ray beams to acquire left, right, and top-down backscatter images simultaneously. The three scanning x-ray beams, indicated by dashed lines emanating from the sources 1, 2, 3, are sequenced temporally. Because only one x-ray beam is active at any given time, the x-ray sources could be mounted so that the beams are essentially coplanar, without any issues of crosstalk between the three views. This allows the system to be quite compact along the direction of motion of the vehicle, the z direction (longitudinal direction) perpendicular to the X-Y plane in which the page is oriented as shown, and in which a vehicle travels through the portal. Accordingly, all three sources can be mounted on a single portal structure, such as illustrated in FIG. 9.

The concept of using mechanical means to temporally interleave the beams was first described by Grodzins in U.S. Pat. No. 6,459,761: “The cross talk between the [backscatter] systems . . . will generally be small since they are relatively far apart, but to completely eliminate that cross talk it is only necessary to interleave the scanning pencil beams. For example, the wheels . . . may each have only two spokes [beam apertures]; the former at say 0 degree and 180 degree, the latter at 90 degree and 270 degree. As the synchronized wheels rotate, the beams incident upon cargo . . . alternate. In this method, the wheels rotate at twice the speed that would be required if each had 4 spokes.” This is the method that has previously been used. Three offset hoops (as shown on the right in FIG. 2C) have been used to form the three sweeping beams. Instead of each hoop containing the usual three beam apertures, each hoop only contained one aperture. The motor controllers used to control the speed of each hoop were adjusted to ensure that the aperture of only one hoop was illuminated at any given time, meaning that only one beam was active at any given time. Note, however, that the three x-ray sources are emitting x-rays continuously within the mechanical hoops, but the position of the apertures within the hoops always prevent the x-rays from escaping from two of the three sources at any given instant.

Accordingly, when implemented in a portal system, embodiments of the current invention are significantly advantageous in over the existing system, since the scanners can be in the same X-Y plane even without temporal interleaving.

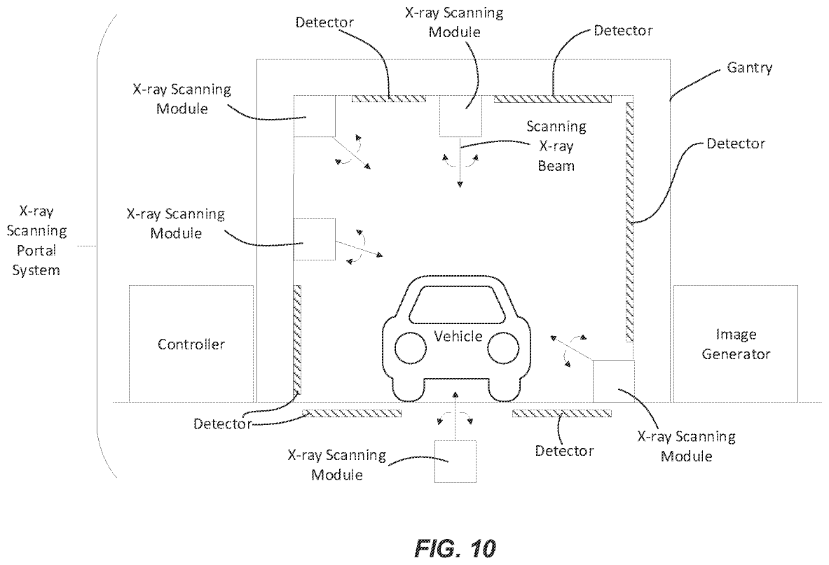

FIG. 10 is an end-view diagram of an embodiment system for imaging a target object with two or more x-ray sources, in the form particularly of an x-ray scanning portal system. The vehicle portal x-ray scanning system of FIG. 10 includes a gantry that is configured to have mounted thereto various x-ray scanning modules, in various locations, as well as various detectors in various locations. Each of the scanning modules is particularly configured to output a scanning x-ray beam, indicated by curved arrows. Via electronic gating, as described hereinabove, each of the x-ray scanning modules is configured to be electronically gated, as to its x-ray source, such that only one scanning x-ray beam is output to intercept the target object (vehicle) at any given moment.

As illustrated in FIG. 10, the x-ray scanning modules may be placed for top view, side view, corner view, bottom view (such as being mounted under the gap system) according to the type and quality and position of scans that are desired for a given application. In addition, as will be understood by those of skill in the art, the detectors may be strategically placed to obtain backscattered images, or scatter images, transmission images, side scanner images, etc., according as is desired. FIG. 10 also illustrates a controller and image generator that perform the functions described in connection with the controller and image generator of FIG. 7. An exception is that the controller of FIG. 10 controls electronic gating of five x-ray scanning modules, instead of only two as in FIG. 7.

Because of the electronic gating, in some applications, signals from the various detectors that are shown in FIG. 10 may be summed to obtain a backscatter image. However, in other applications, it is desirable to select a signal from only one, or selected ones of, the detectors, in order to form the image. For example, if a transmission imaging being obtained, or if a particular type of scattering images being obtained, such as of backscattered image, it may be desirable to select a particular detector or detectors for the image generator to receive signals from, or a particular type of image.

Each of the x-ray scanning modules illustrated in FIG. 10 can include, for example, the x-ray source 402b (x-ray vacuum tube), or the more generalized x-ray source 402a of FIG. 4A. These x-ray source may be electronically gated by negatively charging the gating grid 448 illustrated in FIG. 4B, via the control signal 438 from the controller. The control signal 438 may effect this gating by controlling the driver 440, which supplies drive power to the gating grid 448 via the gating drive electrode 450.

Each x-ray scanning module in FIG. 10 may also include a chopper wheel, such as the chopper wheels illustrated in FIGS. 2A-2C and 3. In such manner, each x-ray scanning module may include a source such as an x-ray tube, and also a scanning means to create a scanning pencil beam, for example.

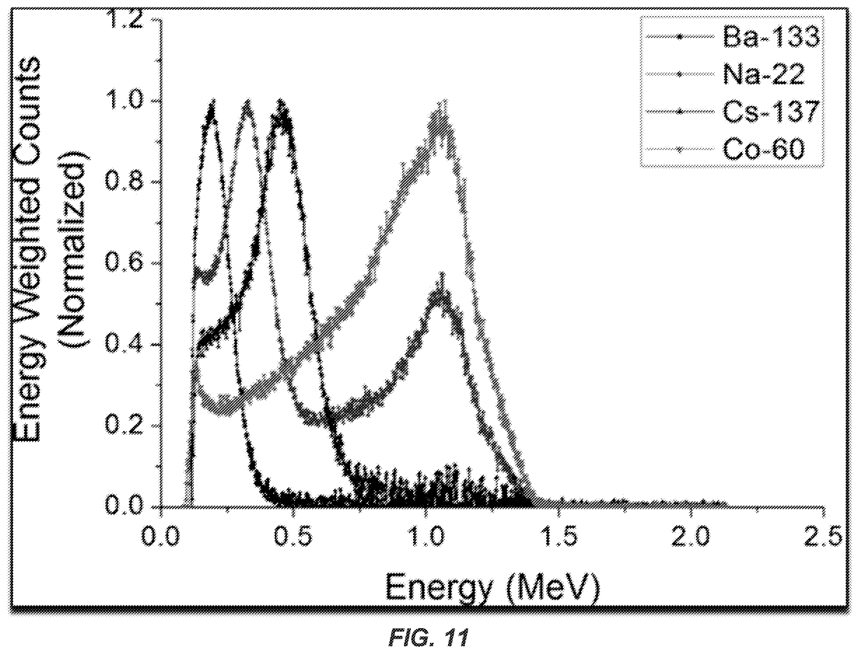

FIG. 11 is a graph showing example spectra of x-ray energies detected in a Radiation Portal Monitors (RPM) based on plastic scintillator material and photomultiplier tubes for four different radioactive isotopes. RPMs are installed at many border crossings and ports to detect the presence of illicit radioactive materials concealed within vehicles or shipping containers. RPMs typically include large volumes of plastic scintillating material such as PVT optically coupled to Photomultiplier Tubes (PMTs) that detect the scintillation light when x-rays or gamma rays deposit their energy in the plastic. The amount of scintillation light produced is proportional to the energy of absorbed x-ray or gamma ray. By measuring the intensity of all the output current pulses produced by the PMTs, an energy spectrum of the absorbed photons can be produced, as shown in FIG. 11 for four different radioactive isotopes. Since plastic scintillator has relatively poor energy resolution (approximately 12% at 662 keV), the peaks corresponding to the concealed isotopes will be quite broad. Nonetheless, given a high enough source strength, they will become detectable above the underlying background counts, as shown.

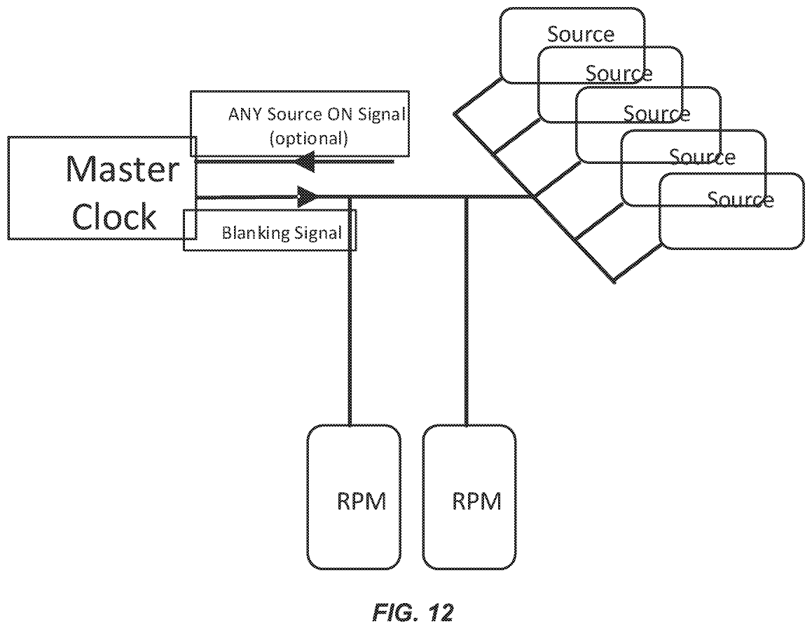

FIG. 12 is a schematic diagram of an embodiment master clock blanking signal arrangement for control of a multi-source x-ray scanning system. In this example there are five x-ray sources and two RPMs. A master clock module produces an output blanking signal that instructs each of the x-ray sources, which can be installed in multiple lanes, to disable x-rays during the duration of the blanking signal. The same signal is used to instruct the RPMs to acquire data during the duration of the signal, or alternatively to ignore any data that is acquired when the blanking signal is not present.

FIG. 13 is a diagram showing example blanking periods that may be used in an embodiment system that includes both a set of one or more embodiment x-ray scanning modules having electronic gating implemented and a set of one or more RPMs. The master clock module produces regularly spaced blanking signals of duration TBlank as shown in the timing diagram in FIG. 13. During the time period TBlank, the RPMs can acquire data and all the x-ray sources are disabled. The blanking pulses are separated by a period of duration TImage. During the period of duration TImage, any x-ray source can be activated if a vehicle is passing through the portal containing the x-ray source. The relative lengths of TBlank and TImage can be selected to minimize the loss in RPM sensitivity, while keeping the reduction in image quality in the x-ray imaging systems at an acceptable level. As an example, a typical backscatter x-ray imaging system will produce one image line per sweep of the beam, with each sweep taking approximately 10 milliseconds. If the blanking time is selected to be 30%, then the blanking pulses will have a duration of TBlank=3 milliseconds with TImage=7 milliseconds. This allows no image lines to be completely skipped.

A disadvantage of the embodiment with the timing diagram shown in FIG. 13 is that the RPMs will not acquire data, even if all the nearby x-ray source are off during times when no vehicle is passing through any of the nearby x-ray imaging portals.

FIG. 14 is a diagram showing example blanking schedule. In this diagram a signal is used that informs the master clock module if any of the nearby x-ray sources is currently active. If no x-ray sources are active, the master clock module automatically outputs a continuous blanking signal, telling the RPMs that they can safely acquire data. This prevents any loss in RPM sensitivity during times when all the nearby x-ray sources are off.

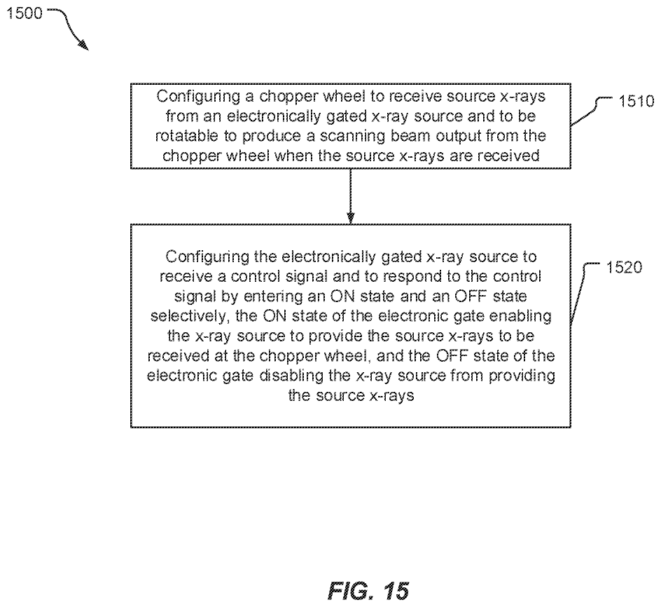

FIG. 15 is a flow diagram illustrating an embodiment method 1500 of manufacturing an x-ray scanning module, in further reference to FIGS. 1-14. At a stage 1510, the method includes configuring a chopper wheel to receive source x-rays from an electronically gated x-ray source and to be rotatable to produce a scanning beam output from the chopper wheel when the source x-rays are received. At a stage 1520, the method includes configuring the electronically gated x-ray source to receive a control signal and to respond to the control signal by entering an ON state and an OFF state selectively, the ON state of the electronic gate enabling the x-ray source to provide the source x-rays to be received at the chopper wheel, and the OFF state of the electronic gate disabling the x-ray source from providing the source x-rays.

The method 1500 may be modified in other embodiment by including any of the features described in relation to other embodiments illustrated, described, or claimed herein as will be apparent to the person of ordinary skill in the art of x-ray scanning in view of this application.

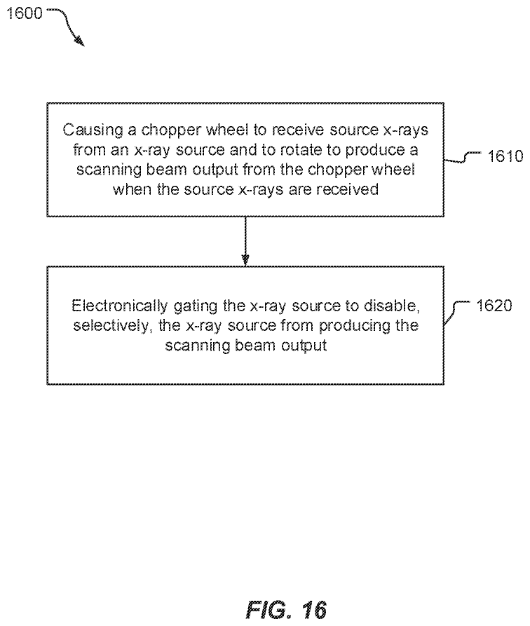

FIG. 16 is a flow diagram illustrating an embodiment method of operating an x-ray scanning module. The method includes, at a stage 1610, causing a chopper wheel to receive source x-rays from an x-ray source and to rotate to produce a scanning beam output from the chopper wheel when the source x-rays are received. At a stage 1620, the method further includes electronically gating the x-ray source to disable, selectively, the x-ray source from producing the scanning beam output.

The method 1600 may be modified in other embodiment by including any of the features described in relation to other embodiments illustrated, described, or claimed herein as will be apparent to the person of ordinary skill in the art of x-ray scanning in view of this application.

Various embodiments of the present invention may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

Without limitation, potential subject matter that may be claimed includes the subject matter set forth in the following clauses:

Clause 1. An x-ray scanning module comprising:
an x-ray source having an electronic gate, the electronic gate configured to have an ON state wherein the electronic gate enables the x-ray source to provide source x-rays, the electronic gate further configured to have on OFF state wherein the electronic gate disables the x-ray source from providing the source x-rays,
wherein the x-ray source is configured to receive a control signal that sets the electronic gate to the ON state and the OFF state selectively; and
a rotatably mounted chopper wheel configured, when the electronic gate is in the ON state, to receive the source x-rays from the x-ray source and to provide a scanning beam output, wherein rotation of the chopper wheel causes scanning of the scanning beam output.

Clause 2. The x-ray scanning module of clause 1, wherein the x-ray source includes an x-ray tube, and wherein the electronic gate is a gating grid within the x-ray tube.

Clause 3. The x-ray scanning module of clause 1, wherein the chopper wheel is selected from the group consisting of a disk chopper wheel, a hub-and-spoke chopper wheel, a hoop chopper wheel, and combinations thereof.

Clause 4. The x-ray scanning module of clause 1, wherein the scanning beam output is a scanning pencil beam output.

Clause 5. The x-ray scanning module of clause 1, wherein the scanning beam output is a scanning fan beam output.

Clause 6. An x-ray scanning system comprising:
the x-ray scanning module according to clause 1; and
a controller configured to output the control signal to the x-ray source and to set, via the control signal, the electronic gate to the ON state and the OFF state selectively.

Clause 7. The system of clause 6, wherein the controller is further configured to set, via the control signal, the electronic gate to be in the OFF state under a circumstance wherein the corresponding source x-rays would interfere with operation of the system.

Clause 8. The system of clause 6, wherein the controller is further configured to set the electronic gate to the ON and OFF states alternating periodically.

Clause 9. The system of clause 6, wherein the controller is further configured to receive an indication of a rotational position of the chopper wheel and to set the electronic gate to the ON state and the OFF state as a function of the rotational position.

Clause 10. The system of clause 6, wherein the scanning beam output is configured scan over a target, the system further including a radiation portal monitor (RPM) configured to detect, passively, ionizing radiation emitted from the target.

Clause 11. The system of clause 10, wherein the controller is further configured to control the RPM to cease the passive detection when the gating signal in the ON state.

Clause 12. The system of clause 10, wherein the controller is further configured to receive an indication of time period of the passive detection and to control the electronic gate to be in the OFF state during the time period of the passive detection.

Clause 13. The system clause 6, further comprising a plurality of x-ray scanning modules according to clause 1, wherein the controller is coupled to each of the electronic gates.

Clause 14. The system of clause 13, wherein the controller is configured to cause a selected one of the electronic gates to disable, selectively, the corresponding x-ray source from providing the corresponding source x-rays.

Clause 15. The system of clause 13, wherein the controller is configured to control the electronic gates such that only a selected one of the electronic gates is in the ON state at a given time.

Clause 16. The system of clause 13, wherein the plurality of x-ray scanning modules form part of a vehicle portal that is configured to obtain a plurality of different x-ray scan views of a vehicle target via respective ones of the plurality of x-ray scanning modules.

Clause 17. The system of clause 16, configured to permit the vehicle target to pass through the vehicle portal in a longitudinal direction during operation of the plurality of x-ray scanning modules, and wherein a maximum separation between any two selected ones of the plurality of x-ray scanning modules, measured in the longitudinal direction, is no greater than four meters.

Clause 18. The system of clause 17, wherein the maximum separation is no greater than 1 meter.

Clause 19. The system of clause 18, wherein the plurality of x-ray scanning modules are positioned essentially in a common plane that is perpendicular to the longitudinal direction.

Clause 20. An x-ray imaging system comprising:
a first electronically gated x-ray source configured to have an activated state and a deactivated state;
a second electronically gated x-ray source configured to have an activated state and a deactivated state;
one or more controllers that control the first and second electronically gated x-ray sources such that only one selected one of the first and second electronically gated x-ray sources is in the activated state at a given time;
one or more x-ray detectors positioned to receive x-rays from both the first and second electronically gated x-ray sources, wherein the x-rays are scattered by the target, transmitted through the target, or both; and
one or more image generators configured to create an image of the target based on signals from at least one of the one or more x-ray detectors when the first x-ray source is active,
wherein the one or more image generators are further configured to create an image of the object based on signals from at least one of the one or more x-ray detectors when the second x-ray source is active.

Clause 21. The system according to clause 20, wherein at least one of the electronically gated x-ray sources contains a gating grid.

Clause 22. The system according to clause 20, wherein at least one of the one or more x-ray detectors is configured to detect x-rays scattered from the target.

Clause 23. The system according to clause 20, wherein at least one of the one or more detectors is configured to detect x-rays transmitted through the target.

Clause 24. The system according to clause 20, wherein the first x-ray source is configured to produce a sweeping pencil beam of x-ray radiation for scanning the target.

Clause 25. The system according to clause 20, wherein the second x-ray source is configured to produce a sweeping pencil beam of x-ray radiation for scanning the target.

Clause 26. The system according to clause 20, wherein the first x-ray source is configured to produce a fan beam of x-ray radiation to be incident on the target.

Clause 27. The system according to clause 20, wherein the second x-ray source is configured to produce a fan beam of x-ray radiation to be incident on the target.

Clause 28. A system for x-ray imaging one or more targets with one or more continuous-beam x-ray sources in close proximity to one or more radiation portal monitors, the system comprising:
one or more continuous-beam x-ray sources, wherein at least one of the one or more x-ray sources is configured to be electronically gated so as to have a selection of states including an activated state and an inactivated state;
one or more radiation portal monitors (RPMs);
a blanking signal controller configured to generate a blanking signal that deactivates the one or more continuous-beam x-ray sources during a blanking period;
one or more x-ray detectors positioned to receive x-rays from the one or more x-ray sources that are scattered by, or transmitted through, the one or more objects;
an image generator configured to create one or more images of the one or more targets based on signals from at least one of the one or more x-ray detectors when at least one of the one or more continuous-beam x-ray sources is in the activated state; and
an RPM signal controller configured to detect passive ionizing radiation emitted passively from the one or more targets during periods when the at least one electronically gated x-ray source is in the inactivated state, the detected passive ionizing radiation based on signals from at least one of the one or more RPMs.

Clause 29. The system according to clause 28, wherein the at least one electronically gated x-ray source contains a gating grid.

Clause 30. The system according to clause 28, wherein blanking signal controller is further configured to generate a periodic blanking signal.

Clause 31. The system according to clause 30, wherein at least one of the one or more continuous-beam x-ray sources is configured to generate line scans of the target with a sweeping x-ray beam, and wherein the periodic blanking signal is shorter than the acquisition time for a given line scan.

Clause 32. The system according to clause 28, wherein the RPM signal controller is configured to be enabled by the blanking signal to acquire data from at least one of the one or more RPMs during periods when the at least one electronically gated x-ray source is in the inactivated state.

Clause 33. The system according to clause 28, wherein the RPM signal controller is configured to acquire data from at least one of the one or more RPMs during periods when all of the one or more x-ray sources are in the inactive state.

Clause 34. The system according to clause 28, wherein at least one of the x-ray sources is configured to produce a sweeping pencil beam of x-ray radiation for scanning at least one of the one or more targets.

Clause 35. The system according to clause 28, wherein at least one of the x-ray sources is configured to produce a fan beam of radiation to be incident on at least one of the one or more targets.

Clause 36. The system according to clause 28, wherein the image generator is configured to replace missing image pixels with interpolated data in the one or more images created by the image generator.

Clause 37. An x-ray scanning module comprising:
an x-ray source configured to be electronically gated to be on and off at different times, corresponding to outputting and not outputting source x-rays, respectively, responsive to an electronic gating signal; and
a chopper wheel configured to receive x-rays resulting from the source x-rays as a function of the electronic gating signal.

Clause 38. The x-ray scanning module of clause 37, wherein the electronic gating signal is synchronized with, or otherwise dependent upon, rotational position of the chopper wheel.

Clause 39. The x-ray scanning module of clause 37, wherein the electronic gating signal is asynchronous with rotational position of the chopper wheel.

Clause 40. A method of manufacturing an x-ray scanning module, the method comprising:
configuring a chopper wheel to receive source x-rays from an electronically gated x-ray source and to be rotatable to produce a scanning beam output from the chopper wheel when the source x-rays are received; and
configuring the electronically gated x-ray source to receive a control signal and to respond to the control signal by entering an ON state and an OFF state selectively, the ON state of the electronic gate enabling the x-ray source to provide the source x-rays to be received at the chopper wheel, and the OFF state of the electronic gate disabling the x-ray source from providing the source x-rays.

Clause 41. A method of operating an x-ray scanning module, the method comprising:
causing a chopper wheel to receive source x-rays from an x-ray source and to rotate to produce a scanning beam output from the chopper wheel when the source x-rays are received; and
electronically gating the x-ray source to disable, selectively, the x-ray source from producing the scanning beam output.

Clause 42. An x-ray scanning module comprising:
means for causing a chopper wheel to receive source x-rays from an x-ray source and to rotate to produce a scanning beam output from the chopper wheel when the source x-rays are received; and
means for electronically gating the x-ray source to disable, selectively, the x-ray source from producing the scanning beam output.

The embodiments of the invention described above are intended to be merely exemplary; numerous variations and modifications will be apparent to those skilled in the art. All such variations and modifications are intended to be within the scope of the present invention as defined in any appended claims.

1. An x-ray scanning module comprising:
an x-ray source having an electronic gate, the electronic gate configured to have an ON state wherein the electronic gate enables the x-ray source to provide source x-rays, the electronic gate further configured to have on OFF state wherein the electronic gate disables the x-ray source from providing the source x-rays,
wherein the x-ray source is configured to receive a control signal that sets the electronic gate to the ON state and the OFF state selectively; and
a rotatably mounted chopper wheel configured, when the electronic gate is in the ON state, to receive the source x-rays from the x-ray source and to provide a scanning beam output, wherein rotation of the chopper wheel causes scanning of the scanning beam output.

2. The x-ray scanning module of claim 1, wherein the x-ray source includes an x-ray tube, and wherein the electronic gate is a gating grid within the x-ray tube.

3. The x-ray scanning module of claim 1, wherein the chopper wheel is selected from the group consisting of a disk chopper wheel, a hub-and-spoke chopper wheel, a hoop chopper wheel, and combinations thereof.

4. The x-ray scanning module of claim 1, wherein the scanning beam output is a scanning pencil beam output.

5. The x-ray scanning module of claim 1, wherein the scanning beam output is a scanning fan beam output.

6. An x-ray scanning system comprising:
the x-ray scanning module according to claim 1; and
a controller configured to output the control signal to the x-ray source and to set, via the control signal, the electronic gate to the ON state and the OFF state selectively.

7. The system of claim 6, wherein the controller is further configured to set, via the control signal, the electronic gate to be in the OFF state under a circumstance wherein the corresponding source x-rays would interfere with operation of the system.

8. The system of claim 6, wherein the controller is further configured to set the electronic gate to the ON and OFF states alternating periodically.

9. The system of claim 6, wherein the controller is further configured to receive an indication of a rotational position of the chopper wheel and to set the electronic gate to the ON state and the OFF state as a function of the rotational position.

10. The system of claim 6, wherein the scanning beam output is configured scan over a target, the system further including a radiation portal monitor (RPM) configured to detect, passively, ionizing radiation emitted from the target.

11. The system of claim 10, wherein the controller is further configured to control the RPM to cease the passive detection when the gating signal in the ON state.

12. The system of claim 10, wherein the controller is further configured to receive an indication of time period of the passive detection and to control the electronic gate to be in the OFF state during the time period of the passive detection.

13. The system claim 6, further comprising a plurality of x-ray scanning modules according to claim 1, wherein the controller is coupled to each of the electronic gates.

14. The system of claim 13, wherein the controller is configured to cause a selected one of the electronic gates to disable, selectively, the corresponding x-ray source from providing the corresponding source x-rays.

15. The system of claim 13, wherein the controller is configured to control the electronic gates such that only a selected one of the electronic gates is in the ON state at a given time.

16. The system of claim 13, wherein the plurality of x-ray scanning modules form part of a vehicle portal that is configured to obtain a plurality of different x-ray scan views of a vehicle target via respective ones of the plurality of x-ray scanning modules.

17. The system of claim 16, configured to permit the vehicle target to pass through the vehicle portal in a longitudinal direction during operation of the plurality of x-ray scanning modules, and wherein a maximum separation between any two selected ones of the plurality of x-ray scanning modules, measured in the longitudinal direction, is no greater than four meters.

18. The system of claim 17, wherein the maximum separation is no greater than 1 meter.

19. The system of claim 18, wherein the plurality of x-ray scanning modules are positioned essentially in a common plane that is perpendicular to the longitudinal direction.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. An x-ray scanning module comprising:
an x-ray source configured to be electronically gated to be on and off at different times, corresponding to outputting and not outputting source x-rays, respectively, responsive to an electronic gating signal; and
a chopper wheel configured to receive x-rays resulting from the source x-rays as a function of the electronic gating signal.

38. (canceled)

39. (canceled)

40. A method of manufacturing an x-ray scanning module, the method comprising:
configuring a chopper wheel to receive source x-rays from an electronically gated x-ray source and to be rotatable to produce a scanning beam output from the chopper wheel when the source x-rays are received; and
configuring the electronically gated x-ray source to receive a control signal and to respond to the control signal by entering an ON state and an OFF state selectively, the ON state of the electronic gate enabling the x-ray source to provide the source x-rays to be received at the chopper wheel, and the OFF state of the electronic gate disabling the x-ray source from providing the source x-rays.

41. A method of operating an x-ray scanning module, the method comprising:
causing a chopper wheel to receive source x-rays from an x-ray source and to rotate to produce a scanning beam output from the chopper wheel when the source x-rays are received; and
electronically gating the x-ray source to disable, selectively, the x-ray source from producing the scanning beam output.

42. An x-ray scanning module comprising:
means for causing a chopper wheel to receive source x-rays from an x-ray source and to rotate to produce a scanning beam output from the chopper wheel when the source x-rays are received; and
means for electronically gating the x-ray source to disable, selectively, the x-ray source from producing the scanning beam output.
